(19) United States
(12) Patent Application Publication
(10) Pub. No.: US 2015/0095661 A1
(43) Pub. Date: Apr. 2, 2015

(54) Flexible Memory Addressing For Data Security

(71) Applicant: Microsoft Corporation, Redmond, WA (US)

(72) Inventors: John V. Sell, Los Altos, CA (US); Ling Tony Chen, Bellevue, WA (US); Paul Paternoster, Los Altos, CA (US)

(73) Assignee: Microsoft Corporation, Redmond, WA (US)

(21) Appl. No.: 14/042,290

(22) Filed: Sep. 30, 2013

(51) Int. Cl. G06F 12/14; G06F 12/10

(52) U.S. Cl. CPC G06F 12/1408; G06F 12/1009
USPC 713/193

(57) ABSTRACT

Regions of system memory in a computer system are managed to maintain privacy and integrity of data. A system address space for memory is divided into a plurality of aliased addressed spaces. Each of the aliased address spaces is associated with its own unique encryption key. The system address space is managed using the aliased address spaces to provide data isolation and privacy for different system processes. One or more aliased address spaces can be provided with additional data integrity capabilities. Data associated with an integrity-checked aliased address space is subjected to data integrity checking, using authentication-based techniques such as hashing, for example. Additionally, a set of contiguous addresses in the aliased address space is defined, while being mapped to a set of non-contiguous addresses in the corresponding physical address space for additional data security.

### BACKGROUND

The disclosed technology is related to data security in computer systems.

Numerous attack avenues that employ a variety of different mechanisms are currently in use that can disrupt normal operation of a computer system. Computer viruses, worms, and trojan horses are examples of different forms of attack. Attacks can also come directly from unscrupulous users of a computer system. Often these attacks take the form of attempts to modify existing program code executed by the computer system or attempts to inject new unauthorized program code at various stages of normal program execution within the computer system. Measures for preventing these types of malicious attacks are becoming increasingly important.

A typical computer system comprises computer hardware, an operating system, and one or more application programs. The computer hardware typically includes a processor (for example, a “central processing unit” or “CPU”), a memory, and one or more system buses that facilitate communication among the various components. Other components of a typical computer system include input/output controllers, a memory controller, a graphics processing unit, an audio controller, and a power supply.

Computer systems generally have a smaller amount of on-chip memory and a larger amount of off-chip memory. On-chip memory commonly includes cache memory, but may also include some portion of system memory. Off-chip memory commonly includes system memory, but may also include cache memory. The off-chip memory in computer systems is often considered to be untrustworthy (on-chip memory may also be considered untrustworthy but can be more easily protected through hardware mechanisms). Data stored in cache or system memory may be vulnerable, and may be altered in a way not intended by the owners of the data. Such an attack can cause a program to operate in an unintended manner or allow a copy protection scheme to be defeated.

The operating system can be thought of as an interface between the application programs and the underlying hardware of the computer system. The operating system typically comprises various software routines that execute on the computer system processor and that manage the physical components of the computer system and their use by various application programs.

Computer systems often include a memory management unit (e.g, provided by the CPU) that manages the use of memory by the operating system and any application programs. Many attacks target programs in memory. For example, portions of code that execute security checks may be defeated by replacing portions of a program when stored in memory.

### SUMMARY

Flexible memory addressing is provided for the maintenance of a system address space to provide data and code isolation, privacy, integrity, and virtualization. A system address space is managed to provide address aliasing that provides isolation of data in a common physical memory. Unique encryption is provided in different aliased address spaces to provide privacy of the isolated data. For example, a system address space for memory is divided into a plurality of aliased addressed spaces in one example. Each of the aliased address spaces is associated with its own unique encryption key. The system address space is managed using the aliased address spaces to provide data isolation and privacy for different system processes.

In one embodiment, one or more aliased address spaces are provided with additional data integrity capabilities. Data associated with an integrity-checked aliased address space is subjected to data integrity checking, for example, using authentication-based techniques such as hashing. Additionally, a set of contiguous addresses in the integrity-checked aliased address space is defined, while being mapped to a set of non-contiguous addresses in the corresponding physical address space for virtualization of the integrity-checked space and flexibility of physical memory allocation.

A controller is provided in one embodiment that is in communication with one or more processors and an system memory. The controller can manage a system address space associated with the system memory to generate a plurality of aliased address spaces. Each aliased address space is associated with a unique encryption key. The controller associates different addresses with different aliased address spaces to provide data isolation and privacy. Memory requests are processed using identified aliased address spaces and encryption keys to provide data security for the different addresses. The controller may further implement integrity-checking of data using an integrity check table for one or more of the aliased address spaces. The data in an integrity-checked space may be virtualized to provide flexibility of physical memory allocation for integrity-checked memory through scatter-mapping of aliased addresses in the physical memory space of the system memory.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a computing system in which embodiments of the disclosure may be implemented.

FIG. 2 is a block diagram depicting management of an address space of system memory in accordance with one embodiment.

FIG. 3 is a block diagram illustrating address translation and data encryption in an aliased address space.

FIG. 4 is a block diagram illustrating address translation and data encryption in an aliased address space, depicting data privacy of a compromised address.

FIG. 5 is a flowchart describing a method for processing memory requests in an aliased address space.

FIG. 6 is a table describing an implementation of an aliased address space.

FIG. 7 is a diagram of the address bit architecture of an aliased address space in one implementation.

FIG. 8 is a block diagram of an integrity check address table in one implementation.

FIG. 9 is a diagram of an address channel implementing an aliased address space in one implementation.

FIG. 10 is a block diagram of a computing system that can be used to implement components and perform methods of the disclosed technology.

### DETAILED DESCRIPTION

System and methods are provided for managing regions of system memory in a computer system to maintain privacy and integrity of data. Encryption techniques are provided for the maintenance of data privacy, and authentication techniques are provided for the maintenance of data integrity. A system address space for memory is divided into a plurality of aliased addressed spaces. Each of the aliased address spaces is associated with its own unique encryption key. The system address space is managed using the aliased address spaces to provide data isolation and privacy for different system processes. In one embodiment, aliased address spaces are used for temporary storage within a CPU or other compute unit. Data and/or code can be encrypted with different keys in the temporary storage within a CPU or security processor for example, and be decrypted when needed for computation.

One or more aliased address spaces are provided with additional data integrity capabilities in one example. Data associated with an integrity-checked aliased address space is subjected to data integrity checking, using authentication-based techniques such as hashing, for example. Additionally, a set of contiguous addresses in the integrity-checked aliased address space is defined, while being mapped to a set of non-contiguous addresses in the corresponding physical address space for virtualization of the integrity-checked space.

A controller is provided in communication with one or more processors and system memory that is accessed by the one or more processors. The system memory may be formed off-chip in relation to the memory controller and processor(s). The controller can manage the system address space of the system memory to provide data isolation and privacy through system address aliasing. The controller associates different processes with different aliased address spaces to provide isolation between data. The associations are dynamic such that processes may be assigned to different address spaces at different times. Moreover, the controller may implement address space assignment based on data attributes such as by managing higher level or risk data in a key space with integrity-checking for example. The controller may include a memory controller and/or memory management unit in various embodiments.

The controller manages an integrity-checked address space of the aliasing to check the integrity of data written to memory in one example. An integrity check table can be used to calculate and store data-dependent hash values when data is written to integrity protected memory. When data is read from an integrity-protected space, the controller can recalculate the hash values and compare them with the values in the integrity check table to verify the data's integrity. The controller may further use an integrity check address table to map aliased address spaces to physical memory locations. A contiguous region of aliased address space can be defined. The table may specify a mapping, on a page-basis for example, from the aliased address space to non-contiguous locations in physical memory.

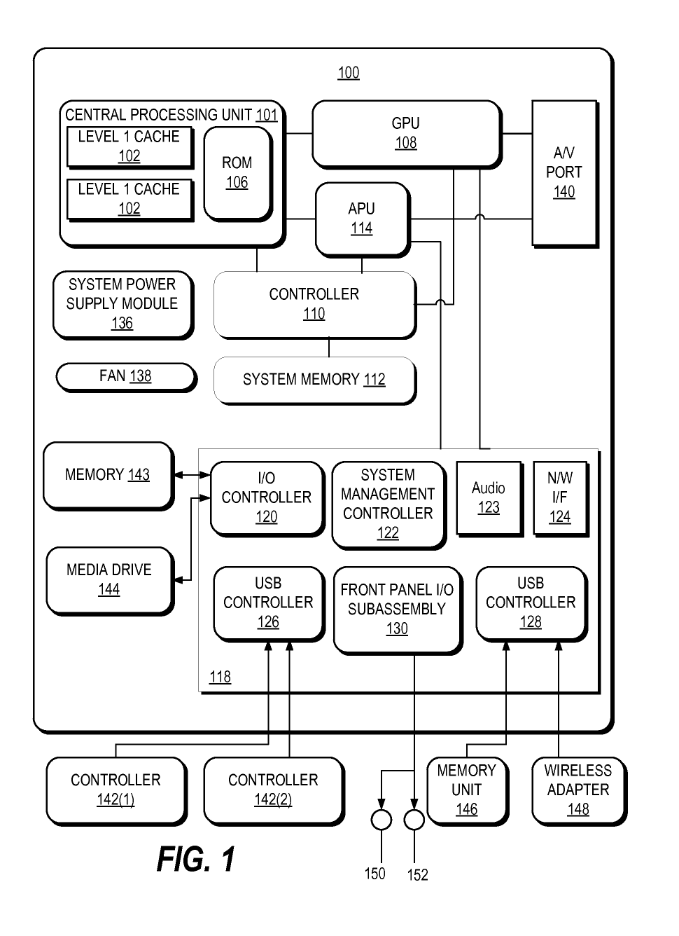

FIG. 1 illustrates the functional components of a computing system 100 such as a multimedia console, depicting one computing environment in which aspects of the disclosure may be implemented. Note that a multimedia console is provided by way of example only as embodiments may be implemented in any general computer system including a processor and system memory.

The computing system 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (not shown) form a video processing pipeline for high speed and high resolution graphics processing. Similarly, an audio processing unit (APU) 114 and audio encoder/audio codec (not shown) form an audio processing pipeline for high speed and high resolution audio processing. Data can be carried from the GPU 108 and APU 114 to the encoders/codecs via a bus. The video and audio processing pipelines output data to an A/V (audio/video) port 140 for transmission to a television or other display.

The computing system 100 includes an I/O controller 120, a system management controller 122, a network interface controller 124, a first USB host controller 126, a second USB controller 128 and a front panel I/O subassembly 130 that may be implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

Non-volatile memory 143, e.g., flash memory, is provided to store application data that is loaded during the boot process. A media drive 144 is provided and may comprise a DVD/CD drive, hard drive, or other removable media drive, etc. The media drive 144 may be internal or external to the computing system 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the computing system 100. The front panel I/O subassembly 130 supports the functionality of the power button 150 and the eject button 152, as well as any LEDs (light emitting diodes) or other indicators exposed on the outer surface of the computing system 100. A system power supply module 136 provides power to the components of the computing system 100. A fan 138 cools the circuitry within the computing system 100.

The CPU 101, GPU 108, controller 110, and various other components within the multimedia console 100 are interconnected via one or more buses, including serial and parallel buses, a memory bus, a peripheral bus, and a processor or local bus using any of a variety of bus architectures.

When the computing system 100 is powered ON, application data may be loaded from the non-volatile memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the computing system 100.

The computing system 100 may be operated as a standalone system by simply connecting the system to a television or other display. In this standalone mode, the computing system 100 allows one or more users to interact with the system, watch movies, or listen to music. However, with the integration of broadband connectivity made available through the network interface 124 or the wireless adapter 148, the multimedia console 100 may further be operated as a participant in a larger network community.

A controller 110 is connected to the CPU 101, GPU 108 and APU 114 to facilitate access and management of system memory 112. Controller 110 may include hardware and/or software for accessing system memory 112. For example, an implementation may include one or more standalone MMU (memory management units) implemented as part of CPU 101 in one example. Controller 110 may include hardware-based memory controllers. Software-based implementations may include a controller incorporated within the operating system provided by CPU 101, for example. An MMU is provided in the operating system layer of the computing system in one example. System memory 112 may include but is not limited to, RAM (Random Access Memory) such as DRAM (Dynamic RAM). The controller may be responsible for handling memory access requests associated with the various processors. Other functions performed by the controller may include the translation of virtual addresses to physical addresses (i.e., virtual memory management), memory protection, cache control, and so on.

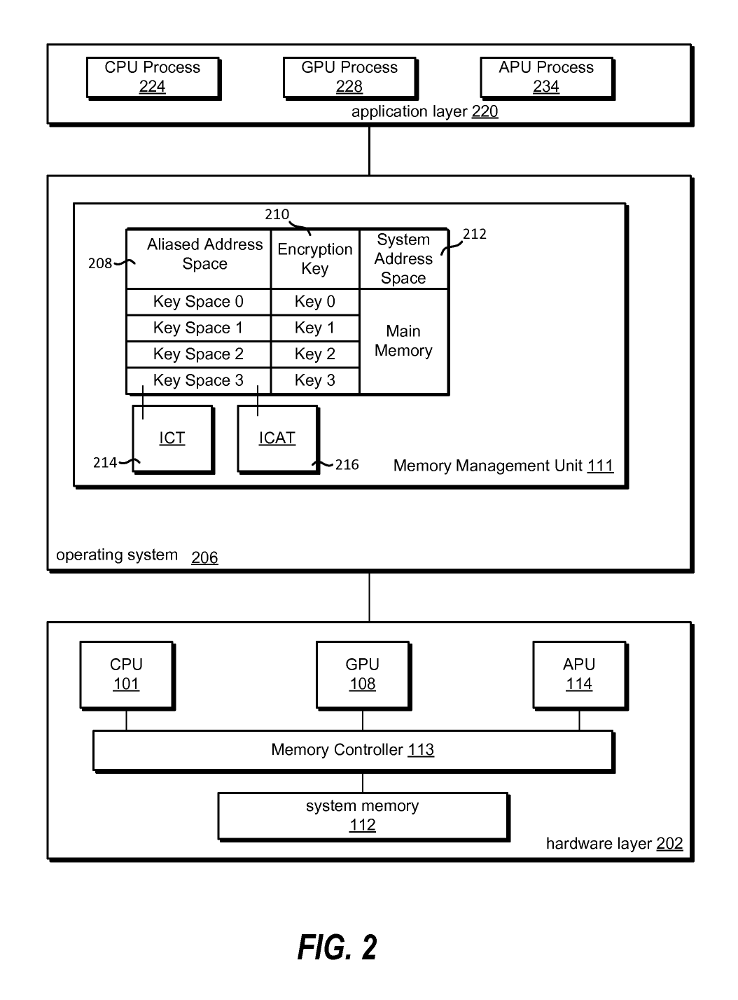

FIG. 2 is a block diagram depicting further details of a computing system as illustrated in FIG. 1. In FIG. 2, CPU 101, GPU 108, and APU 114, memory controller 113, and system memory 112 are part of a hardware layer 202. For example, various components may be incorporated in a single integrated circuit to form a SoC (system-on-chip) comprising on-chip hardware layer 202. A system-on-chip (SoC) typically integrates the components of an electronic system such as a computer into a single integrated circuit or chip. In one embodiment, system memory 112 may be incorporated into a different integrated circuit. In such examples, system memory 112 may be considered untrustworthy because of its off-chip relation to the various processors of the SoC. For example, external connections may be provided to connect the two hardware layers, providing a point of vulnerability in the system.

Memory management unit 111 (MMU) manages access to system memory 112 by the various processors. MMU 111 may translate virtual addresses allocated to system processes into physical addresses used by system memory 112. MMU 111 in this example is implemented as part of the operating system 206 layer but may include components of the various processors and/or other management circuitry. The operating system 206 may include hypervisors, host operating systems, guest operating systems, as well as components of the overall operating software. MMU 111 maintains regions of system memory to provide both privacy and integrity of data. Memory controller 113 may perform various encryption and integrity check functions described herein.

MMU 111 provides and manages a plurality of aliased address spaces 208 generated from the system address space 212 to provide isolation and privacy of data between different processes executed by the system. The system address space corresponds to system memory 112 and is divided into four aliased address spaces, also referred to as key spaces. The use of four aliased address spaces is provided only by way of example. Any number of key spaces may be used according to a given implementation. In FIG. 2, key space 0, key space 1, key space 2, and key space 3 are defined for system address space 212. Each key space individually maps to system address space 212. In this manner, four individual views into system memory 112 are provided that facilitate data and code isolation within the common system memory. Memory controller 110 uses a unique encryption key for each key space to facilitate code and data privacy in the common system memory. In this example, key 0 is associated with key space 0, key 1 is associated with key space 1, key 2 is associated with the key space 2, and key 3 is associated with key space 3. Note that four key spaces are provided by way of example only. Any number of key spaces and encryption keys may be defined in a given implementation for a system address space.

An example is illustrated in FIG. 2 where three processes are executing in an application layer 220. MMU 111 handles memory access requests such as read and write requests for a CPU process 224, a GPU process 228 and an APU process 234. MMU 111 allocates and manages memory to provide security of data for the various processes, including data and code isolation and privacy using the aliased address spaces. In the current example, MMU 111 allocates memory to CPU process 224 using the key space 0 aliased address space, allocates memory to GPU process 228 using the key space 1 aliased address space, and allocates memory to APU process 234 using the key space 2 aliased address space. Note that these allocations are dynamic such that the MMU may assign a process to any available key space, as well as switch assignments as memory is reclaimed. Processes may be re-assigned to different aliased address spaces. In one embodiment, processes may be assigned to aliased address spaces based on data type. For example, a process including digital rights management data or data associated with operating system processes may be assigned to an integrity-checked key space.

MMU 111 maps virtual addresses that are allocated to CPU process 224 to aliased system addresses in key space 0. Virtual addresses allocated to GPU process 228 are mapped to aliased system addresses in key space 1 and virtual addresses allocated to APU process 234 are mapped to aliased system addresses in key space 2. In this manner, MMU 111 will map data and code associated with the different processes to isolated regions of physical memory. Moreover, memory controller 113 encrypts the data and code associated with the different processes using different encryption keys. The data for system addresses in key space 0 for CPU process 224 are encrypted with key 0, data for system addresses in key space 1 for GPU process 228 are encrypted with key 1, and data for system addresses in key space 2 for APU process 232 are encrypted with key 2. Similarly, when accessing data in system memory 112, memory controller 128 decrypts data associated with CPU process 224 using key 0, data associated with GPU process 228 using key 1, and data associated with APU process 234 using key 2.

In this manner, a process that attempts to access the physical address space associated with another process will not be able to decrypt the data. For example, if GPU process 228 is compromised and is used to access the aliased address space of CPU process 224, the data will be decrypted using key 1. Because the data was encrypted using key 0, however, the GPU process cannot gain access to the unencrypted data even if it gains access to the aliased address space.

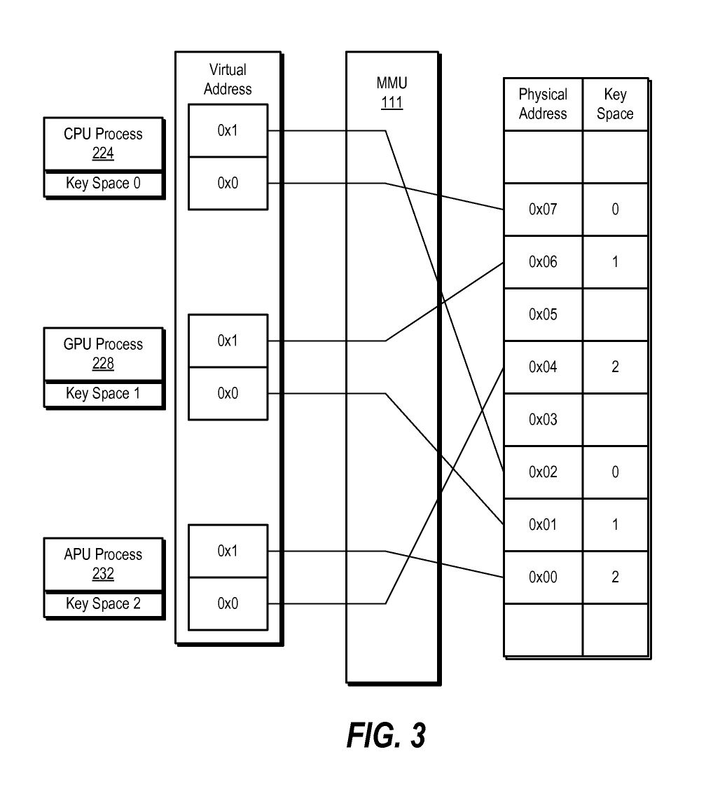

FIG. 3 is a block diagram depicting a mapping of virtual addresses to physical addresses in accordance with an embodiment that illustrates data isolation and privacy provided by an aliased system address space. MMU 111 associates CPU process 224 with key space 0, GPU process 228 with key space 1 and APU process 166 with key space 2. MMU 111 may use page tables (not illustrated) to map virtual addresses allocated to different processes to system addresses associated with system memory 112. Moreover, MMU 111 maps the individual processes to different key spaces of the system memory. Although described with respect to processes for ease of explanation, key spaces can be more generally associated with physical addresses. A key space may be used for code or data, for a set of processes, and various combinations. Moreover, although only a portion of physical addresses are shown as part of a key space, every physical address can be part of one of the key spaces.

In the particular example, CPU process 224 is associated with key space 0 and is allocated virtual addresses 0x1 and 0x0. MMU 111 maps virtual address 0x1 to physical address 0x01 of system memory 112 and virtual address 0x0 to physical address 0x07. Moreover, MMU 111 associates physical addresses 0x02 and 0x07 with key space 0. Similarly, the MMU associates GPU process 228 with key space 1, and maps its virtual address allocation to physical addresses 0x01 and 0x06 which are in turn associated with key space 1. Finally, APU process 232 is associated with key space 2, and memory controller 110 maps its virtual addresses to physical addresses 0x00 and 0x04 which are associated with key space 2. The MMU may utilize spare physical address bits, virtual address bits and/or page tables to manage the various key space designations. For example, the MMU may map allocate virtual addresses to processes having a key space designation in the virtual address in one example. In another example, the page tables may define mapping of virtual addresses to system addresses with particular key space designations. The MMU may allocate virtual addresses based on these mappings. In yet another example, the MMU may map virtual addresses to system addresses having a particular key space designation in the system address.

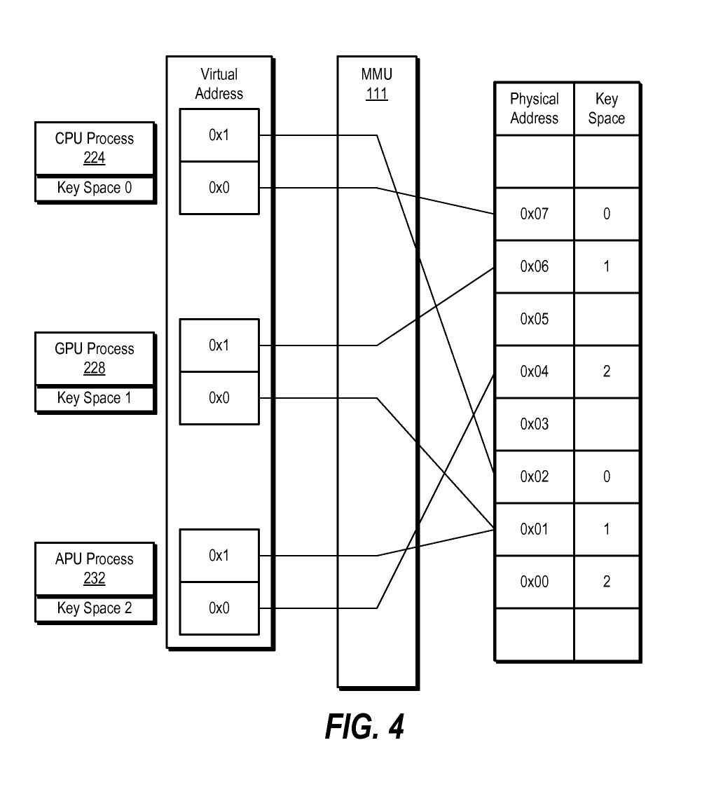

FIG. 4 is a block diagram illustrating data privacy provided by the aliased system address space. Continuing with the example of FIG. 3, FIG. 4 illustrates an example where APU process 232 is used to access memory space allocated to GPU process 228. For example, the APU process may be compromised to gain access to the system memory storing data in the APU's mapped virtual memory space. In this example, the virtual address 0x1 for APU process 232 is mapped to physical address 0x01. As noted, physical address 0x01 stores data associated with the GPU process 228 and is associated with key space 1. Because APU process 166 is associated with key space 2, MMU 111 uses encryption key 2 to decrypt the data at physical address 0x01. Since the data was encrypted with encryption key 1 but decoded with encryption key 2, however, the data is not decipherable or otherwise useful, despite the compromise allowing access to the memory space.

Returning to FIG. 2, there is also provided a fourth aliased address space denoted as key space 3. Key space 3 is an integrity-checked key space that provides authentication techniques to maintain integrity of data transferred to system memory 112 using key space 3. In one embodiment, memory controller 113 calculates a data-dependent value for portions of the data in key space 3 using a hash-based algorithm for example. Memory controller 113 can compute hash values for each cache line and store the hash values in ICT 214 (Integrity Check Table) when data is written to system memory 112. The hash value can be calculated again when data is read from the system memory 112 and compared with the value in the ICT 214. If the values do not match, the system determines that the integrity of the data has been compromised.

Memory controller 113 also provides unique memory management of the data in key space 3 to facilitate further security. The data in key space 3 is scatter-mapped within the physical address space of system memory 112. Memory controller 113 provides a contiguous system address space within integrity protected key space 3, while providing a non-contiguous address space in the corresponding physical address space. The memory controller uses ICAT 216 (Integrity Check Address Table) in one embodiment to provide mapping between the aliased system address space and the physical address space of system memory 112. The memory controller may setup the ICAT table based on pages. Physical memory locations within the system memory 112 can be accessed on a page basis, by hardware for example, using the mapping in the ICAT table. The ICAT table may include an index of system page addresses in the integrity-protected key space. The ICAT table includes an output for each system page address location in the physical address space of the system memory. By using non-contiguous portions of the physical address space in the ICAT definition, the system can map a contiguous system address space to non-contiguous portions of system memory 112.

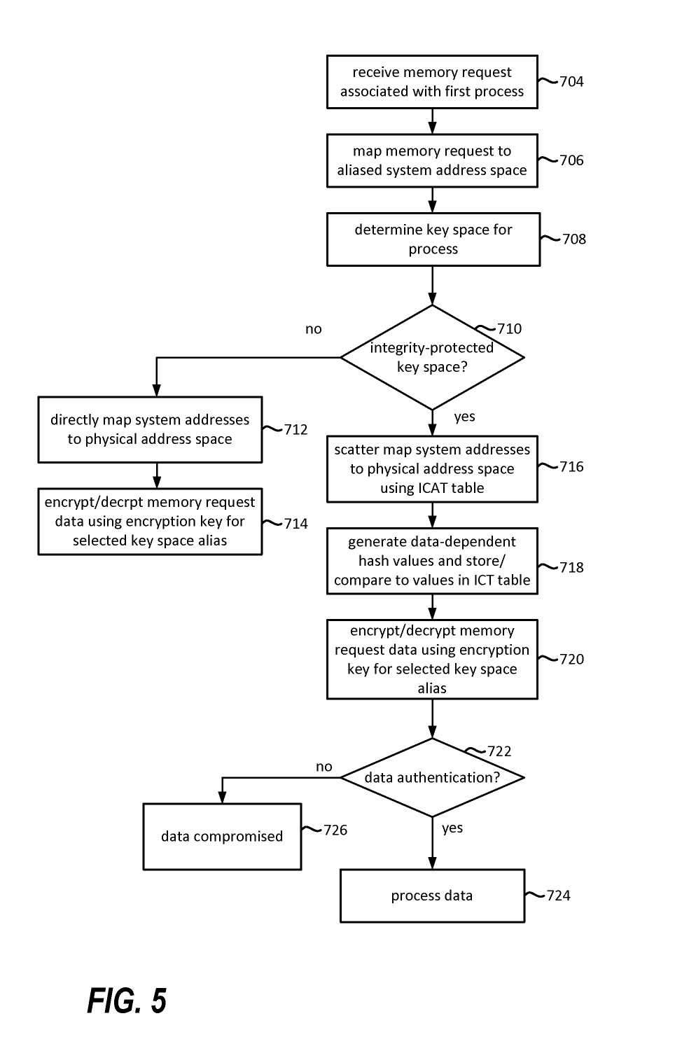

FIG. 5 is a flowchart describing processing by a controller including a MMU and/or memory controller in accordance with one embodiment to process a request to access data in system memory. At step 704, an MMU receives a request to write data to or read data from the system memory. At step 706, the MMU determines a process associated with the request, and a key space for the corresponding process. Although step 706 in this example associates key spaces with specific processes, key spaces may more generally be associated with specific addresses. In this manner, various code, data, sets of processes and numerous other combinations may be used for assigning key spaces. At step 708, the MMU maps one or more virtual addresses of the request to an aliased system address space. Steps 706 and 708 may be performed in any order. The key space may be encoded in a virtual address received at step 704 or in a translated system address from the mapping at step 706, for example. Moreover, the MMU may utilize page tables or other techniques to determine a process and key space corresponding to a memory request.

At step 710, the MMU determines whether the key space is an integrity-protected key space. If the key space is not integrity-protected, the MMU directly maps the system addresses from the system addresses to physical memory locations at step 712. The memory controller accesses a unique encryption key for the key space at step 714 and encrypts or decrypts the data for the memory request using the unique encryption key for the key space.

If the MMU determines that the key space is integrity-protected at step 710, the memory controller scatter-maps the pages of the memory request within the physical address space of the system memory at step 716. Step 716 can include mapping contiguous system address locations to non-contiguous physical memory locations in the physical address space using an ICAT table as described. The memory controller generates data-dependent hash values for the write request at step 718. The hash values may be calculated for individual pages, for example. If the memory request is a write request, the memory controller stores the values in an ICT. If the memory request is a read request, the memory controller compares the values with previously stored values in the ICT for the corresponding addresses. At step 720, the memory controller encrypts or decrypts the memory request data using the unique encryption key for the key space. In one example, the hash values are computed on the encrypted data as well as the original request data. Steps 716 and 720 can be performed in any order

If the memory request is a read request, the memory controller accesses the results of the comparison at step 718 to determine whether the data in system memory is authenticated against the data in the ICT at step 722. If the hash values in the table match the calculated hash values, the memory controller process the read request data at step 724, for example by issuing data to the requesting process. If the hash values do not match however, the memory controller determines that the data has been compromised at step 726. Various actions can be taken at step 726. For example, an alert can be generated or error correction controls may be applied to determine if the correct data can be determined and authenticated.

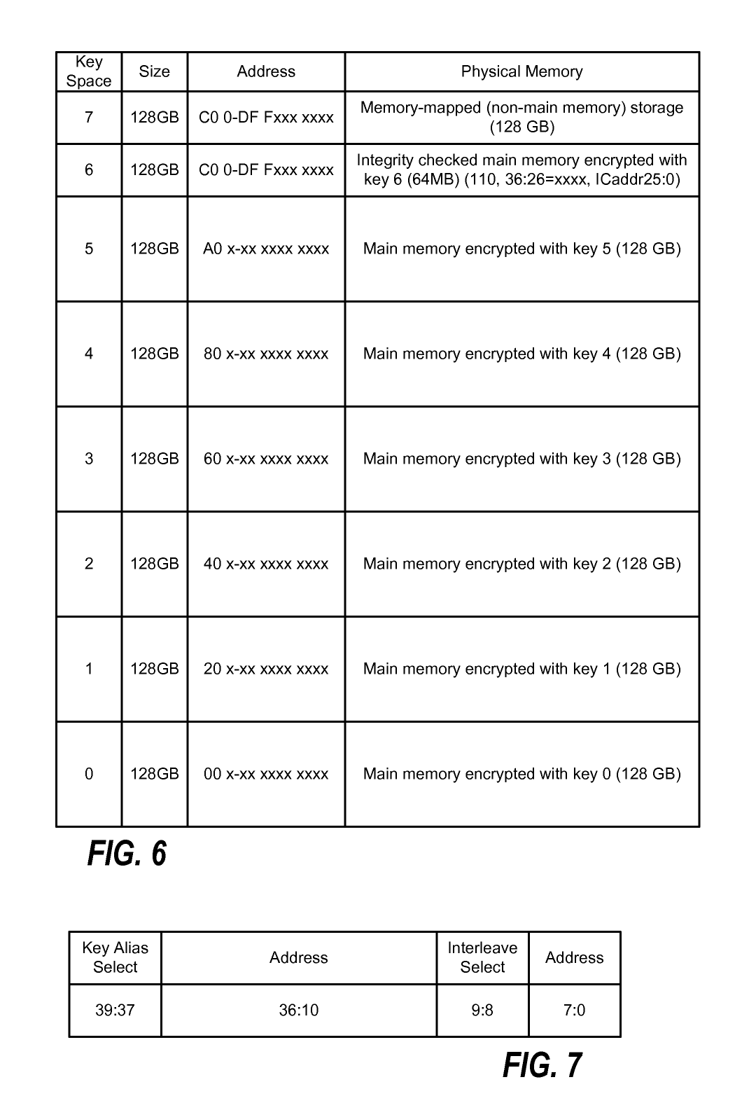

FIG. 6 is a diagram depicting an example of an implementation of key space aliasing of a system address space according to one embodiment. In FIG. 6, an ‘n’ bit system address space is provided having ‘a’ alias select bits and ‘b’ bits of physical addresses. In this example the system address space is 1 TB (n=40) having three (a=3) alias select bits and thirty-seven (b=37) bits of physical addresses. Using three alias select bits, the 1 TB system address space can be divided into eight aliased address spaces or eight key spaces. The actual physical memory (e.g., system memory in FIG. 2) is assumed to be 16 GB in FIG. 6, although any size memory may be used.

Key spaces 0-5 are encrypted aliased address spaces. Within each key space, the 1 TB address space is divided into eight 128 GB spaces. Embodiments may not include the divisions illustrated in FIG. 6 in other implementations. As illustrated, the data in each of key spaces 0-5 is encrypted with a unique encryption key 0-5 for each key space. Data is encrypted within each key space and decrypted within each key space using the key unique to its key space. In this manner, even if memory is accessed from outside of a key space, it will not be able to be decrypted.

Key space 6 is an encrypted and integrity-checked key space within the system address space. In this example, 64 MB of the available 16 GB of physical address space are used within key space 6. Data within key space 6 is encrypted with the key unique to key space 6, and is also subjected to integrity checking and scatter mapping within the physical address space. Data-dependent hash values of the data within key space 6 can be calculated when data is stored. When data is read from key space 6, the hash values can be re-calculated and compared with the stored values. If the values do not match, the data may considered compromised and appropriate action taken for loss of integrity. These values can be stored in ICT 214 on on-chip hardware layer 202. Consider an example where a system utilizes 64 byte cache lines (‘e’ number of bits=6). If 64 MB of address space are integrity checked, the integrity check value table will include entries for 1 MB of address space (1 million entries). If the hash value for each cache line is 2 bytes for example, 2 MB of storage can be used to maintain the ICT table.

Key space 6 also includes scatter-mapping of a contiguous system address space to a non-contiguous locations in physical memory. Memory controller 113 maps a contiguous 64 MB region (number of bits ‘c’=26) of the 128 GB aliased address space to non-contiguous portions of the 16 GB of physical system memory in this example. A page-based mapping can be utilized to scatter pages of the 64 MB of memory within system memory 112. Consider an example where ‘d’ address bits are used to designate a page. For example, d is equal to 21 where a 2 MB page size is used. Where a 64 MB integrity-checked space is used, a total of number of ‘c’ address bits equal to 26 is used for addressing. Accordingly, the ICAT will include an index for the 32 (2̂c-d) pages that are scatter-mapped to physical memory locations. If the physical memory size is 16 GB, there are 8K (8192) pages available to store the 32 integrity-checked pages. Accordingly, the ICAT may include 13 bits for each of the 32 indexed entries to indicate a corresponding physical page location.

Each key space represents a full ability to address the full system memory address space of 128 GB. Thus, each aliased key space 0-8 can fully address the system address space, providing eight unique ways of addressing the same 128 GB of system address space. Accordingly, the addresses indicated FIG. 6 permit eight variations for addressing the 128 GB system address space. Specifically in this example, three additional address bits above the 128 GB space are used to uniquely identify the eight aliased address spaces identified as key spaces 0-8. In FIG. 6, key space 7 is a non-encrypted standard memory-mapped (non-main memory storage) aliased address space.

FIG. 7 depicts a set of physical address bits and their designations for implementing an aliased system address space in accordance with one embodiment. In this example, a 40 bit (‘n’=40) system address space is utilized. Bits 0 through 7 and 10 through 36 are standard address bits used to designate physical addresses. Bits 8 and 9 are utilized to implement a four-way channel interleave address architecture. Bits 37 through 39 (‘a’=3) are key space alias address select bits. Three bits are utilized to provide designations for eight unique alias spaces as shown in FIG. 6.

FIG. 7 depicts a specific example where physical address bits are utilized as alias select bits to designate the different key spaces. Other techniques may be used. For example, operating system page tables may be used to assign and manage different aliased physical address spaces without using physical address bits. In one implementation, virtual address bits may be used to designate aliased spaces.

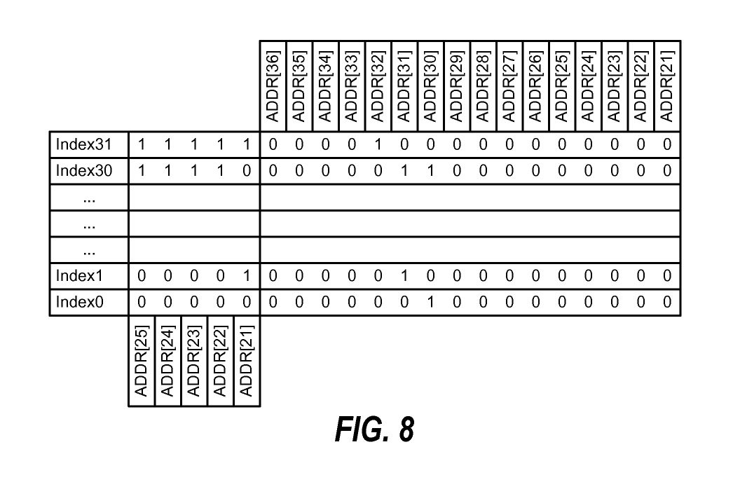

FIG. 8 is a block diagram illustrating an ICAT table and a technique of scatter-mapping a contiguous aliased system address space to non-contiguous locations in physical memory. In FIG. 8, the addressing example of FIG. 7 is continued. Address bits 21-25 index into the ICAT table, defining 32 index entries labeled Index0-Index31. Based on an input of address bits 21-25, an output for physical address bits 21-36 are generated. The address provided by bits 21-36 for each entry provides a location of where the corresponding page indicated by input address bits 21-25 is located in physical memory. Index 0 corresponds to the lowest addressed 2 MB page. The output value of address bits 21-36 indicates that Index0 maps to a 1 GB base on the physical memory. Index 1, corresponding to the next highest addressed page, maps to a 2 GB base in the physical memory. Also indicated are Index 30 which maps to a 3 GB base in physical memory and Index 31 which maps to a 4 GB base in physical memory.

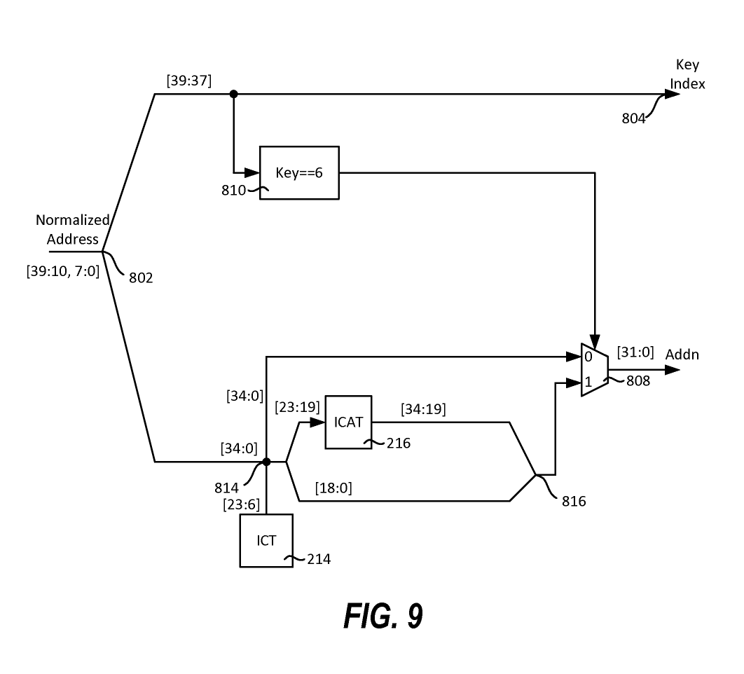

FIG. 9 is a block diagram depicting an address translation channel for an aliased system address space in accordance with one embodiment. This embodiment continues with the example of address bits provided in FIG. 7. FIG. 9 further depicts a single channel view of a four-way channel interleave address scheme. As earlier described, bits 8:9 can be used to select one of four address channels. In this example, a single address channel is depicted, after filtering bits 8:9. Accordingly, a normalized system address including bits 39:10 and 7:0 are received. The bits are split at node 802. The highest three bits, 39:37, are alias select bits as earlier described. They are used to select the key space and are not used for physical addressing. Accordingly, these bits are provided as a key index at node 804. If bits 39:37 indicate key space 6, the integrity protected key space, the key is provided as a selection input 810 to multiplexor 808.

Bits 34:0 are provided as an input at node 814. Bits 34:0 in an non-translated form are passed as input for selection by multiplexor when the key space is not integrity-protected. Bits 23:6 are additionally provided as an index into ICT table 214 to provide integrity checking for the data. Bits 23:6 select a cacheline for computing a hash-value in one example. Bits 23:0 are passed through node 814.

Bits 23:19 are provided as the index into ICAT 216 to translate the system address to a physical address location. It is noted that bits 23:19 correspond to bits 25:21 in FIG. 7. The bits are shifted down by two to account for the normalization due to removing the interleave bits. System address bits 23:19 are used as index into the ICAT to select physical address bits 34:19 as an output of the ICAT. Again, bits 34:19 are downshifted by two according to the normalization. Translated bits 34:19 and non-translated bits 18:0 are combined at node 816 and provided as in input to multiplexor 808 for selection of translated values.

If the selected key space is key space 6, multiplexor 808 selects the logic 1 inputs corresponding to the scatter-mapped addresses in the physical memory locations. Multiplexor 808 selects the translated address bits 31:19 which have been combined with non-translated address bits 18:0. If the selected key space is one of key spaces 0-5, multiplexor 808 selects the logic 0 inputs corresponding to the non-translated addresses. Original system address bits 34:0 are selected.

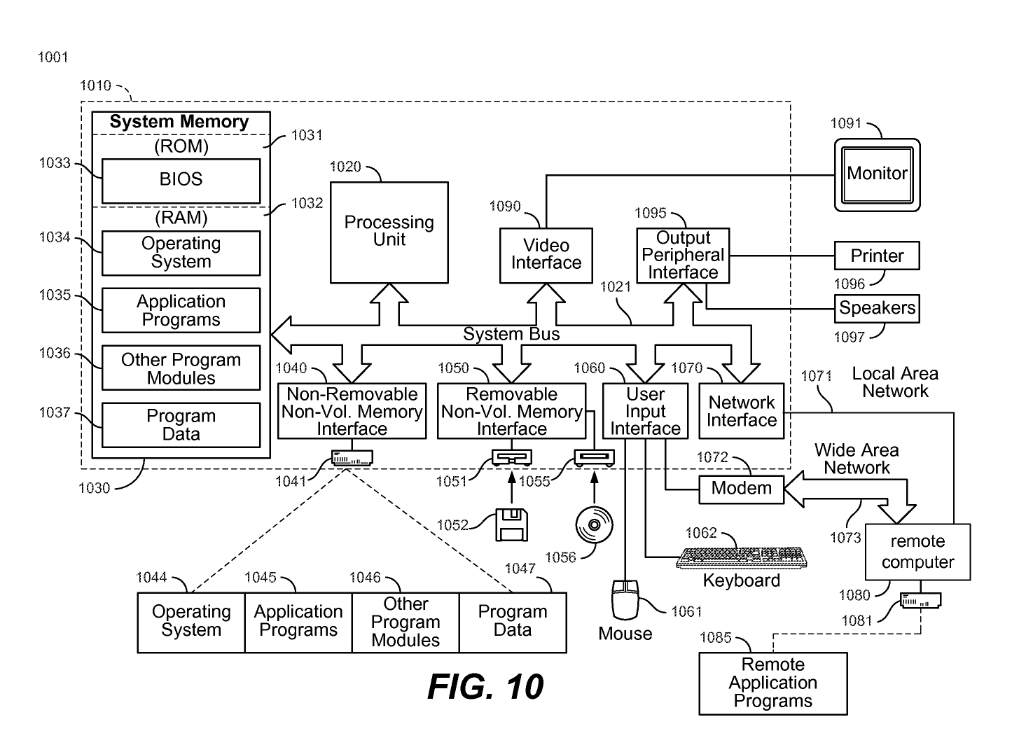

FIG. 10 illustrates another example of a computing environment that may be used to implement aspects of the present disclosure. An example system for implementing the various components of the described system and method may include a general purpose computing device 1010. The computing device may be used to implement servers or other computing machines for these components. The computing device 1010 is only one example of a suitable computing system and is not intended to suggest any limitation as to the scope of use or functionality of the presently disclosed subject matter. Neither should the computing device be interpreted as having any dependency or requirement relating to any one or combination of components illustrated in the exemplary operating system. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Components of computing device 1010 may include, but are not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 1010 may include a variety of computer readable media. Computer readable media can be any available media that can be accessed by computing device 1010 and includes both volatile and nonvolatile media, removable and non-removable media. By way of example, and not limitation, computer readable media may comprise computer readable storage media and communication media. Computer readable storage media includes volatile and nonvolatile, as well as removable and non-removable media implemented in any method or technology for storage of information such as computer readable instructions, data structures, program modules or other data. Computer readable storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the information and which can be accessed by computing device 1010. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

The system memory 1030 includes computer storage media in the form of volatile and/or nonvolatile memory such as ROM 1031 and RAM 1032. A basic input/output system (BIOS) 1033, containing the basic routines that help to transfer information between elements within computing device 1010, such as during start-up, is typically stored in ROM 1031. RAM 1032 typically contains data and/or program modules that are immediately accessible to and/or presently being operated on by processing unit 1020. By way of example, and not limitation, FIG. 9 illustrates operating system 1034, application programs 1035, other program modules 1036, and program data 1037.

The computing device 1010 may also include other removable/non-removable, volatile/nonvolatile computer storage media. By way of example only, FIG. 10 illustrates a hard disc drive 1041 that reads from or writes to non-removable, nonvolatile magnetic media and a magnetic disc drive 1051 that reads from or writes to a removable, nonvolatile magnetic disc 1052. Computing device 1010 may further include an optical media reading device 1055 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 1041 is typically connected to the system bus 1021 through a non-removable memory interface such as interface 1040. Magnetic disc drive 1051 and optical media reading device 1055 are typically connected to the system bus 1021 by a removable memory interface, such as interface 1050.

The drives and their associated computer storage media discussed above provide storage of computer readable instructions, data structures, program modules and other data for the computing device 1010. In FIG. 10, for example, hard disc drive 1041 is illustrated as storing operating system 1044, application programs 1045, other program modules 1046, and program data 1047. These components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies.

A user may enter commands and information into the computing device 1010 through input devices such as a keyboard 1062 and a pointing device 1061, commonly referred to as a mouse, trackball or touch pad. Other input devices (not shown) may include a microphone, joystick, game pad, satellite dish, scanner, or the like. These and other input devices are often connected to the processing unit 1020 through a user input interface 1060 that is coupled to the system bus 1021, but may be connected by other interface and bus structures, such as a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computing device 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computing device 1010, although only a memory storage device 1081 has been illustrated in FIG. 10. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computing device 1010 is connected to the LAN 1071 through a network interface or adapter 1070. When used in a WAN networking environment, the computing device 1010 typically includes a modem 1072 or other means for establishing communication over the WAN 1073, such as the Internet. The modem 1072, which may be internal or external, may be connected to the system bus 1021 via the user input interface 1060, or other appropriate mechanism. In a networked environment, program modules depicted relative to the computing device 1010, or portions thereof, may be stored in the remote memory storage device. By way of example, and not limitation, FIG. 10 illustrates remote application programs 1085 as residing on memory device 1081. It will be appreciated that the network connections shown are exemplary and other means of establishing a communication link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

What is claimed is:

1. A system, comprising:
at least one memory having a physical address space;
at least one processor in communication with the at least one memory; and
a controller in communication with the at least one processor and the at least one memory, the controller manages a system address space associated with the at least one memory, the controller generates a plurality of aliased address spaces for the system address space and associates an encryption key with each of the aliased address spaces, the controller processes a first memory request using a first aliased address space and a first encryption key associated with the first aliases address space and processes a second memory request using a second aliased address space and a second encryption key associated with the second aliased address space.

2. A system according to claim 1, wherein:
the first memory request is associated with a first process and the second memory request is associated with a second process;
the controller processes a third memory request associated with the first process using a third aliased address space and a third encryption key associated with the third aliased address space; and
the controller processes a fourth memory request associated with the second process using a fourth aliased address space and a fourth encryption key associated with the fourth aliased address space.

3. A system according to claim 1, wherein:
the plurality of aliased address spaces includes a third aliased address space associated with a third encryption key;
the controller processes a third memory request associated with the third aliased address space using the third encryption key, the controller calculates one or more hash values associated with data for the memory request and stores the one or more hash values in an integrity check table; and
the controller maps a set of contiguous aliased addresses in the third aliased address space to a set of non-contiguous addresses in the physical address space.

4. A system according to claim 3, wherein:
the controller maps the set of contiguous aliased addresses to the set of non-contiguous addresses in the physical space using an integrity check address table (ICAT), the ICAT includes an index of aliased page addresses in the aliased address space and an output of physical page addresses in the physical address space.

5. A system according to claim 4, wherein.
the aliased address space includes a plurality of address bits, the plurality of address includes a first subset of alias select bits and a second subset of physical address bits

6. A system according to 1, wherein the controller includes a memory management unit configured by the at least one processor.

7. A system according to 1, wherein the memory controller includes a memory management unit configured by the at least one processor and a memory controller.

8. A method of memory management in a computing system, comprising:
providing a first aliased address space and a second aliased address space for a system address space associated with at least one memory, the first aliased address space being associated with a first encryption key and the second aliased address space being associated with a second encryption key;
associating a first process with the first aliased address space and a second process with the second aliased address space; and
processing a first set of memory requests associated with the first process and the at least one memory using the first aliased address space and the first encryption key and processing a second set of memory requests associated with the second process and the at least one memory using the second aliased address space and the second encryption key.

9. A method according to claim 8, further comprising:
providing a third aliased address space for the system address space associated with the at least one memory, the third aliased address space being associated with a third encryption key and including a integrity-protected memory space;
associating a third process with the third aliased address space;
processing a third set of memory requests associated with the third process and the at least one memory using the third aliased address space and the third encryption key;
generating and storing a set of data-dependent hash values for the third memory request; and
mapping a set of contiguous addresses in the third aliased address space to a set of non-contiguous addresses in a physical address space of the at least one memory.

10. A method according to claim 9, wherein storing the set of data-dependent hash values comprises:
generating data for a first table having an index of page addresses for the third memory request and an output of the hash values based on the index, each hash value being calculated from data of a corresponding page address.

11. A method according to claim 10, wherein mapping the set of contiguous addresses in the third aliased address space comprises:
generating data for a second table having an index of page addresses from the third aliased address space and an output of page addresses in the physical address space of the at least one memory.

12. A method according to claim 8, further comprising:
providing a plurality of bits for the physical address space;
designating a subset of the plurality of bits as alias select bits;
wherein providing a first key space alias includes providing a first designation in the alias select bits of the plurality of bits; and
wherein providing a second key space alias includes providing a second designation in the alias select bits of the plurality of bits.

13. A method according to claim 8, further comprising:
allocating a first virtual address to the first process and a second virtual address to the second process, the first virtual address and the second virtual address being part of a virtual address space having a plurality of bits;
designating a subset of the plurality of bits as alias select bits;
wherein providing a first key space alias includes providing a first designation in the alias select bits of the plurality of bits; and
wherein providing a second key space alias includes providing a second designation in the alias select bits of the plurality of bits.

14. A method according to claim 8, wherein the memory requests are memory write requests, the method further comprises:
receiving from the first process and the second process memory read requests associated with the physical memory;
decrypting data from the physical memory for the memory read requests of the first process using the first encryption key based on the first key space alias and decrypting data from the physical memory for the memory read requests of the second process using the second encryption key based on the second key space alias.

15. A computer readable storage medium having computer readable instructions for programming a processor to perform a method comprising:
providing a first aliased address space and a second aliased address space for a system address space associated with at least one memory, the first aliased address space being associated with a first encryption key and the second aliased address space being associated with a second encryption key;
associating a first process with the first aliased address space and a second process with the second aliased address space;
processing a first set of memory requests associated with the first process and the at least one memory using the first aliased address space and the first encryption key and processing a second set of memory requests associated with the second process and the at least one memory using the second aliased address space and the second encryption key.

16. A computer readable storage medium according to claim 15, wherein the method further comprises:
providing a third aliased address space for the system address space associated with the at least one memory, the third aliased address space being associated with a third encryption key and including an integrity-protected memory space;
associating a third process with the third aliased address space;
processing a third set of memory requests associated with the third process and the at least one memory using the third aliased address space and the third encryption key;
generating and storing a set of data-dependent hash values for the third memory request; and
mapping a set of contiguous addresses in the third aliased address space to a set of non-contiguous addresses in a physical address space of the at least one memory.

17. A computer readable storage medium according to claim 16, wherein storing the set of data-dependent hash values comprises:
generating data for a first table having an index of page addresses for the third memory request and an output of the hash values based on the index, each hash value being calculated from data of a corresponding page address

18. A computer readable storage medium according claim 17, wherein mapping the set of contiguous addresses in the third aliased address space comprises:
generating data for a second table having an index of page addresses from the third aliased address space and an output of page addresses in the physical address space of the at least one memory.

19. A computer readable storage medium according claim 15, wherein the method further comprises:
providing a plurality of bits for the physical address space;
designating a subset of the plurality of bits as alias select bits;
wherein providing a first key space alias includes providing a first designation in the alias select bits of the plurality of bits; and
wherein providing a second key space alias includes providing a second designation in the alias select bits of the plurality of bits.

20. A computer readable storage medium according to claim 15, further comprising:
allocating a first virtual address to the first process and a second virtual address to the second process, the first virtual address and the second virtual address being part of a virtual address space having a plurality of bits;
designating a subset of the plurality of bits as alias select bits;
wherein providing a first key space alias includes providing a first designation in the alias select bits of the plurality of bits; and
wherein providing a second key space alias includes providing a second designation in the alias select bits of the plurality of bits.
